(19) United States
(12) Patent Application Publication
(10) Pub. No.: US 2026/0216591 A1
(43) Pub. Date: Jul. 30, 2026

(54) COMPUTER-IMPLEMENTED METHOD, ONE OR MORE COMPUTER-READABLE STORAGE MEDIA, AND GAME SYSTEM

(71) Applicant: Nintendo Co., Ltd., Kyoto (JP)

(72) Inventors: Hiroki HAMAUE, Kyoto (JP); Ryo KATAOKA, Kyoto (JP)

(21) Appl. No.: 19/570,057

(22) Filed: Mar. 17, 2026

Related U.S. Application Data
(63) Continuation of application No. PCT/JP2023/037530, filed on Oct. 17, 2023.

(51) Int. Cl. A63F 13/211; A63F 13/24

(52) U.S. Cl. CPC A63F 13/211; A63F 13/24

(57) ABSTRACT

A mouse has an aperture of a light guide path linked to a sensor for operating the mouse, in a bottom surface of the mouse. It is determined whether the mouse is in a first orientation in which the bottom surface is exposed, based on first data output from the mouse. When it is determined that the mouse is in the first orientation, a first game process is executed based on second data that is output from the sensor for operating the mouse when an object to be detected is positioned closer to the aperture.

### CROSS REFERENCE TO RELATED APPLICATION

This application is a continuation of International Patent Application No. PCT/JP2023/037530 filed on Oct. 17, 2023, the entire contents of which are incorporated herein by reference.

### FIELD

The technology disclosed herein relates to computer-implemented methods, computer-readable storage media, and game systems, and more particularly, to a computer-implemented method, one or more computer-readable storage media, and a game system in which a process using a mouse is executed, for example.

### BACKGROUND AND SUMMARY

There has conventionally been a video game apparatus that executes a game using a pointing device such as a mouse as an input apparatus.

However, there has been room for improvement in amusingness in terms of a method for operating the video game apparatus using a mouse.

The present example discloses a computer-implemented method, one or more computer-readable storage media, and a game system in which novel operation experience and amusingness can be provided in terms of operation of a mouse.

The present example may have the following features (1) to (18), for example.
(1) In an example configuration of a computer-implemented method according to the present example, a mouse has an aperture of a light guide path linked to a sensor for operating the mouse, in a bottom surface of the mouse, and based on first data output from the mouse, it is determined whether the mouse is in a first orientation in which the bottom surface is exposed. When it is determined that the mouse is in the first orientation, a first game process is executed based on second data that is output from the sensor for operating the mouse when an object to be detected is positioned closer to the aperture.
(2) In the configuration of (1), the second data may include data related to a movement operation direction in which the object to be detected has been moved over the aperture. The first game process may include a process based on the movement operation direction.
(3) In the configuration of (1), the second data may include data related to a movement operation speed at which the object to be detected has been moved over the aperture. The first game process may include a process based on the movement operation speed.
(4) In the configuration of any one of (1) to (3), the first game process may be executed when the second data is output after the second data has not been output.
(5) In the configuration of any one of (1) to (3), the first game process may be executed when the second data is no longer output after the second data has been output.
(6) In the configuration of any one of (1) to (5), based on the first data, it may be further determined whether the mouse is in a second orientation different from the first orientation. When it is determined that the mouse is in the second orientation, the first game process may be executed based on third data that is output from an operation means that is provided on the mouse and is different from the sensor for operating the mouse.
(7) In the configuration of any one of (1) to (6), the mouse may include an orientation sensor for detecting the orientation of the mouse. The first data may include data based on the orientation sensor.
(8) In the configuration of any one of (1) to (7), the first game process may be based on the first data.
(9) In the configuration of any one of (1) to (8), the first game process may be a process of determining a first parameter of a virtual object in a virtual space based on the first data, determining a second parameter of the virtual object based on the second data, and controlling a motion of the virtual object in the virtual space based on the determined first and second parameters.
(10) In the configuration of any one of (1) to (9), the first orientation may be an orientation in which the bottom surface of the mouse faces upward. The second data may include data related to the movement operation direction in which the object to be detected is moved over the aperture. In the case in which the forward, backward, leftward, and rightward directions of the mouse are defined based on the orientation of the mouse in which the mouse is operated with the light guide path placed on a placement surface, the first game process may include a process based on a forward and rightward direction in the virtual space when the defined forward and leftward direction is detected as the movement operation direction based on the second data, and a process based on a forward and leftward direction in the virtual space when the defined forward and rightward direction is detected as the movement operation direction based on the second data.
(11) In the configuration of any one of (1) to (10), the first orientation may be an orientation in which the bottom surface of the mouse faces upward. The second data may include data related to the movement operation direction in which the object to be detected is moved over the aperture. In the case in which the forward, backward, leftward, and rightward directions of the mouse are defined based on an orientation of the mouse in which the mouse is operated with the light guide path placed on a placement surface, the first game process may include a process based on a forward and diagonally downward direction in the virtual space when the second data is obtained in a state in which, based on the first data, it is determined that the mouse is in the first orientation in which a direction toward the front of the base surface is tilted in the defined upward direction, and a process based on a forward and diagonally upward direction in the virtual space when the second data is obtained in a state in which, based on the first data, it is determined that the mouse is in the first orientation in which a direction toward the front of the base surface is tilted in the defined downward direction.
(12) In the configuration of any one of (1) to (11), the mouse may include a direction input unit on a side surface thereof. In the first game process, a virtual object may be moved in the virtual space based on fourth data that is output according to an operation performed on the direction input unit.
(13) In the configuration of (12), in the first game process, an action of a virtual object may be controlled based on the second data.
(14) In the configuration of any one of (1) to (13), based on the first data, it may be further determined whether the mouse is in a second orientation in which the bottom surface is placed on a placement surface. When it is determined that the mouse is in the second orientation, a third game process may be further executed based on second data that is output from the sensor for operating the mouse when the mouse is moved on the placement surface.
(15) In the configuration of any one of (1) to (14), a first button and a second button may be provided and positioned such that the aperture is interposed therebetween on the bottom surface in the longitudinal direction of the mouse. When it is determined that the mouse is in the first orientation, a fourth game process may be further executed based on fifth data that is output according to an operation performed on the first button, and a fifth game process may be further executed based on sixth data that is output according to an operation performed on the second button.
(16) In the configuration of (15), the aperture may be formed closer to the first button than the second button in the longitudinal direction. When the fifth data and the second data are simultaneously received, only one or none of the first game process and the fourth game process may be executed. When the sixth data and the second data are simultaneously received, both of the first game process and the fifth game process may be executed, or a game process different from the first game process and the fifth game process may be executed.
(17) In the configuration of (1), the second data may include data related to the movement operation direction in which the object to be detected is moved over the aperture. In the case in which the forward, backward, leftward, and rightward directions of the mouse are defined based on the orientation of the mouse in which the mouse is operated with the light guide path of the mouse placed on a placement surface, the first game process may include a process that is executed based on the front-back direction or the top-bottom direction in the virtual space when the defined left-right direction is detected as the movement operation direction based on the second data.
(18) In the configuration of (1), the second data may include data related to the movement operation direction in which the object to be detected is moved over the aperture. In the case in which the forward, backward, leftward, and rightward directions of the mouse are defined based on the orientation of the mouse in which the mouse is operated with the light guide path of the mouse placed on a placement surface, the first game process may include a process that is executed based on the left-right direction in the virtual space when the defined front-back direction is detected as the movement operation direction based on the second data.

In addition, the present example may be carried out in the forms of one or more computer-readable storage media and a game system. An example of the one or more computer-readable storage media of the present example may store instructions that, when executed, cause one or more processors in an information processing apparatus to execute the above processes.

According to the present example, a mouse can be operated using a novel operation method, and novel amusingness can be provided.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a block diagram showing a non-limiting example of a configuration of an information processing system 1a according to a first embodiment,

FIG. 2 is a diagram showing a non-limiting example of an appearance of an input apparatus 3,

FIG. 3 is a diagram showing a non-limiting example of an upside-down orientation operation of an input apparatus 3,

FIG. 4 is a diagram showing a non-limiting example of a game image displayed according to an operation performed on an input apparatus 3 in a non-limiting example of a game process in the first embodiment,

FIG. 5 is a diagram showing another non-limiting example of a game image displayed according to an operation performed on an input apparatus 3 in a non-limiting example of a game process in the first embodiment,

FIG. 6 is a diagram showing a non-limiting example in which a reference direction is changed to a top-bottom direction in a virtual space,

FIG. 7 is a diagram showing a non-limiting example of main data and programs stored in a storage unit 22 of an information processing apparatus 2 in the first embodiment,

FIG. 8 is a flowchart showing a non-limiting example of a process that is executed in an information processing apparatus 2 according to the first embodiment,

FIG. 9 is a subroutine showing a non-limiting specific example of an object motion control process in step S55 of FIG. 8,

FIG. 10 is a diagram showing a non-limiting example of an appearance of an input apparatus 9,

FIG. 11 is a diagram showing a non-limiting example of a landscape holding operation of an input apparatus 9,

FIG. 12 is a diagram showing a non-limiting example of an operation of blocking an aperture in a landscape holding operation of an input apparatus 9,

FIG. 13 is a diagram showing a non-limiting example of a game image that is displayed according to a direction instruction operation performed on an input apparatus 9 in a non-limiting example of a game process in a second embodiment,

FIG. 14 is a diagram showing a non-limiting example of a game image that is displayed according to an operation of blocking an aperture of an input apparatus 9 in a non-limiting example of a game process in the second embodiment,

FIG. 15 is a diagram showing a non-limiting example of an appearance of an input apparatus 9a,

FIG. 16 is a diagram showing a non-limiting example of main data and programs stored in a storage unit 22 of an information processing apparatus 2 in the second embodiment,

FIG. 17 is a flowchart showing a non-limiting example of a process that is executed in an information processing apparatus 2 according to the second embodiment, and

FIG. 18 is a subroutine showing a non-limiting example of an object motion control process in step S104 of FIG. 17.

### DETAILED DESCRIPTION OF NON-LIMITING EXAMPLE EMBODIMENTS

### First Embodiment

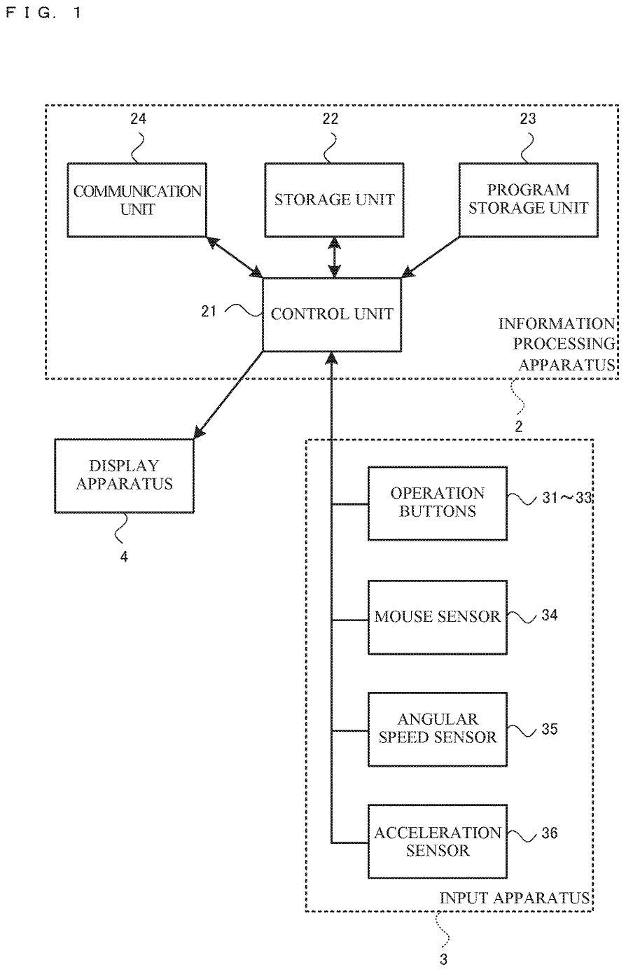

An information processing system 1a according to a first embodiment will be described with reference to FIG. 1. As shown in FIG. 1, the information processing system 1a includes an information processing apparatus 2, an input apparatus 3, and a display apparatus 4, which are connected to each other wirelessly or by a cable. For example, in the information processing system 1a, a process is executed by the information processing apparatus 2 based on an output of the input apparatus 3 that is produced when the input apparatus 3 is operated by the user, and a result of the execution is displayed on the display apparatus 4. It should be noted that the information processing system 1a may have a plurality of input apparatuses 3 connected to the information processing apparatus 2 wirelessly or by a cable. In that case, the plurality of input apparatuses 3 may be operated by the same user or different users.

The information processing apparatus 2 is configured to be able to connect to a network through wireless or wired communication so as to be able to connect to and communicate with other apparatuses (e.g., a server and another information processing apparatus 2). The information processing apparatus 2 is able to execute a predetermined application (e.g., a game application). For example, the information processing apparatus 2 is able to execute an information processing program that is stored in a storage medium such as a removable memory card or optical disc, or that is received from another apparatus. The information processing apparatus 2 may be a device such as a typical personal computer, stationary game machine, smartphone, handheld game, or the like.

The information processing apparatus 2 includes a control unit 21, a storage unit 22, a program storage unit 23, and a communication unit 24. It should be noted that the information processing apparatus 2 may be composed of at least one apparatus including an information processing apparatus including at least the control unit 21, and another apparatus(s).

The control unit 21 is an information processing means (computer) for executing various information processes, e.g., a CPU. For example, the control unit 21 has the function of executing a game process described below, a process of transmitting and receiving data to and from another apparatus, and the like by executing the above application as the various information processes. Each function of the control unit 21 is carried out by the CPU executing a predetermined program.

The storage unit 22 stores various types of data that are used when the control unit 21 executes the above information processes. The storage unit 22 is, for example, a memory that can be accessed by a CPU (e.g., the control section 21).

The program storage unit 23 stores programs. The program storage unit 23 may be any storage apparatus (storage medium) that can be accessed by the control unit 21. For example, the program storage unit 23 may be a non-volatile memory. In addition, the program storage unit 23 may be a storage apparatus that is connected to the control unit 21 via a network (e.g., a server).

The communication unit 24, which includes a predetermined communication module, exchanges data with another apparatus (e.g., the server 200 and another information processing apparatus 2) via a network, or directly exchanges data with another information processing apparatus 2 (e.g., local communication).

In the case in which the information processing apparatus 2 includes a stationary game apparatus or a personal computer, the display apparatus 4 may be separated from the information processing apparatus 2. In another example, the display apparatus 4 may be integrated with the body of the information processing apparatus 2.

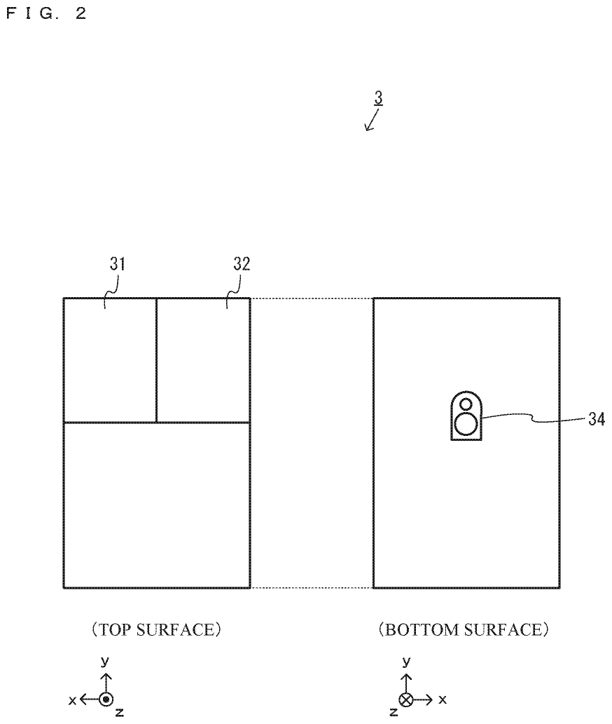

As shown in FIG. 2, the input apparatus 3 has the mouse function. As used herein, an input apparatus having the mouse function is referred to as a “mouse”. Here, the mouse function includes at least the function of outputting operation data indicating the movement direction and movement distance of the input apparatus 3 when the body of the input apparatus 3 is moved on a surface where the input apparatus is placed (hereinafter referred to as a “placement surface”) with the bottom surface of the input apparatus 3 facing the placement surface. The information processing apparatus 2 may, for example, move a cursor or the like displayed on the display apparatus 4 based on operation data.

The input apparatus 3 includes a mouse sensor 34 for carrying out the mouse function. The mouse sensor 34, which is, for example, an optical sensor using an LED, may be similar to a sensor that is used in conventional mice. The mouse sensor 34 may, for example, be a sensor that uses laser light or infrared light. In the present example, the mouse sensor 34 is disposed in the body of the input apparatus 3 at a position where the mouse sensor 34 is exposed to the outside through a through hole formed in the bottom surface. Thus, the through hole, which is an aperture formed in a portion of the bottom surface, forms a light guide path linked to the mouse sensor 34. When the input apparatus 3 is placed on the placement surface with the bottom surface of the input apparatus 3 facing the placement surface, the mouse sensor 34 emits light to the placement surface, detects the light reflected from the placement surface, and executes an image process to calculate parameters (e.g., a movement direction and a movement distance) related to the movement of the input apparatus 3. It should be noted that the calculation of the parameters based on the result of detection of the reflected light may be performed in the input apparatus 3 or in the information processing apparatus 2, which receives, from the input apparatus 3, information about the result of detection of the reflected light.

It should be noted that the input apparatus 3 may calculate a parameter related to the current position of the input apparatus 3 with respect to a reference position based on the result of detection of the reflected light in the mouse sensor 34, in addition to or instead of the parameters related to the movement direction and movement distance of the input apparatus 3, and output the parameter related to the current position to the information processing apparatus 2.

In addition, the input apparatus 3 may calculate a parameter related to the orientation of the input apparatus 3 based on the result of detection of the reflected light in the mouse sensor 34, in addition to or instead of the parameters related to the movement direction and movement distance of the input apparatus 3 and the parameter related to the position of the input apparatus 3, and output the parameter related to the orientation to the information processing apparatus 2. For example, the calculation of the parameter related to the orientation of the input apparatus 3 may be performed based on the result of detection by an inertial sensor such as an angular velocity sensor 35 or an acceleration sensor 36 described below, or based on the result of detection of reflected light by at least one mouse sensor 34. It should be noted that the calculation of the parameters related to the position and/or orientation may also be performed in the input apparatus 3 or in the information processing apparatus 2, which receives information about the result of detection by the inertial sensor or the result of detection of reflected light from the input apparatus 3. Since the calculation of the parameters related to the position and/or orientation is performed in the input apparatus 3, the information processing apparatus 2 can execute an accurate process even when the transmission of data from the input apparatus 3 to the information processing apparatus 2 is temporarily interrupted.

In addition, in the case in which the calculation of parameters related to the movement of the input apparatus 3 (parameters related to the movement direction, movement distance, position, orientation, and the like of the input apparatus 3) is performed in the information processing apparatus 2, these parameters may be calculated by execution of a game application as a portion of a game process described below, or a process different from a process using the game application.

The input apparatus 3 includes at least one operation button. For example, the input apparatus 3 shown in FIG. 2 includes two operation buttons 31 and 32 on a top surface thereof. The operation buttons 31 and 32 output operation data to the control unit 21 in response to the pressing operation.

In this embodiment, in order to make it easier to understand the directions of the input apparatus 3, the front-back direction is defined as the longitudinal direction of the top surface of the input apparatus 3, the left-right direction is defined as the transverse direction of the top surface of the input apparatus 3, and the top-bottom direction is defined as the direction perpendicular to the top surface of the input apparatus 3. In addition, three axial directions (x-, y-, and z-axial directions) are defined with respect to the input apparatus 3 as indicated in FIG. 2. Specifically, the positive direction of the z-axis is defined as the upward direction of the input apparatus 3 from the bottom surface toward the top surface of the input apparatus 3 when the input apparatus 3 is placed and operated, facing the placement surface. The positive direction of the y-axis is defined as the direction toward the front (the side of the top surface of the input apparatus 3 on which the operation buttons 31 and 32 are provided) in the longitudinal direction perpendicular to the top-bottom direction. The positive direction of the x-axis is defined as the leftward direction of the left-right direction that is the transverse direction perpendicular to the top-bottom direction, with reference to the upward direction and the forward direction. Thus, in this embodiment, the upward, downward, leftward, rightward, forward, and backward directions are defined such that when the input apparatus 3 is in an orientation in which the input apparatus 3 is placed and operated on the placement surface with the bottom surface of the input apparatus 3 facing the placement surface, the downward direction is defined as the direction from the top surface toward the bottom surface, and the forward direction is defined as the direction toward the side of the top surface on which the operation buttons 31 and 32 are provided.

The input apparatus 3 includes an angular velocity sensor 35 and an acceleration sensor 36 in addition to the operation buttons 31 and 32 and the mouse sensor 34. The input apparatus 3 may include only one of the angular velocity sensor 35 and the acceleration sensor 36. The angular velocity sensor 35 and the acceleration sensor 36 are an inertial sensor that detects the orientation and motion of the input apparatus 3. The angular velocity sensor 35 and the acceleration sensor 36 are connected to the control unit 21. The result of detection by the angular velocity sensor 35 and/or the acceleration sensor 36 is output to the control unit 21. The control unit 21 is capable of calculating information about the motion and/or orientation of the input apparatus 3 based on the result of detection by the angular velocity sensor 35 and/or the acceleration sensor 36.

It should be noted that the input apparatus 3 may be any input apparatus that is configured to be able to be operated by the user. For example, the input apparatus 3 may be in the form of a game controller that is lifted and held by one or both hands of the user. The input apparatus 3 may be removably attached to the information processing apparatus 2 or the display apparatus 4. The input apparatus 3 may be integrated with the information processing apparatus 2 or the display apparatus 4. In addition, in addition to or instead of the operation buttons 31 and 32, the input apparatus 3 may be provided with other input means such as other operation buttons, a stick, and a touch panel. In the case in which the input apparatus 3 is integrated and constructed in a predetermined embodiment, the input apparatus 3 may be constructed such that the surface of the input apparatus 3 on which the mouse sensor 34 is provided faces a corresponding member and is not exposed. It should be noted that the input apparatus 3 may be configured to be able to switch the mouse function on/off.

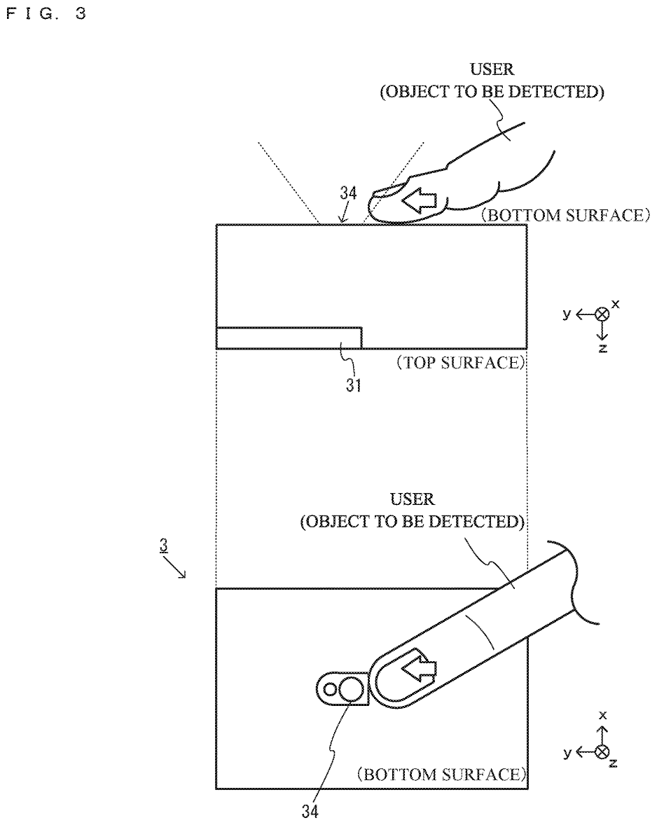

As shown in FIG. 3, in the present example, it is also possible to execute a process based on an operation of the input apparatus 3 with the input apparatus 3 lifted from the placement surface and turned upside down (the bottom surface and the top surface are reversed) (hereinafter referred to as an “upside-down orientation operation”). In the upside-down orientation operation, the input apparatus 3 is operated with the bottom surface of the input apparatus 3 facing upward and the top surface of the input apparatus 3 facing downward (the positive direction of the z-axis pointing in the gravitational direction). As shown in FIG. 3, when the input apparatus 3 is in an orientation in which the bottom surface thereof is lifted from the placement surface and faces upward, it may be determined whether the upside-down orientation operation is being performed, using the motion and orientation of the input apparatus 3 calculated based on the result of detection of an inertial sensor such as the angular velocity sensor 35 or the acceleration sensor 36. For example, the output range of the angular velocity sensor 35 when the bottom surface of the input apparatus 3 faces upward is previously set, and if the output falls within the range, it may be determined that the upside-down orientation operation is being performed. This determination may be performed in the input apparatus 3, or in the information processing apparatus 2, which receives information about the result of detection by the inertial sensor from the input apparatus 3. In addition, in the case in which the determination is performed in the information processing apparatus 2, the determination may be performed as a portion of a game process described below by execution of a game application, or a process different from a process using the game application. By thus performing the orientation determination based on the output of the inertial sensor of the input apparatus 3, it can be accurately determined whether the upside-down orientation operation of the input apparatus 3 is being performed.

The upside-down orientation operation of the input apparatus 3 may be detected using other techniques. As shown in FIG. 3, when the input apparatus 3 is in an orientation in which the bottom surface of the input apparatus 3 is lifted from the placement surface and faces in a direction other than the downward direction, the mouse sensor 34 cannot detect reflected light, so that an output indicating detection of sufficient reflected light cannot be obtained from the mouse sensor 34. Therefore, by detecting an output from the mouse sensor 34 in such a state, it can be determined that the input apparatus 3 is in an orientation in which the bottom surface of the input apparatus 3 is exposed and lifted from the placement surface. In another example, based on the output produced when the mouse sensor 34 cannot detect sufficient reflected light, it may be determined that the upside-down orientation operation is being performed with the input apparatus 3 being in an orientation in which the bottom surface of the input apparatus 3 is exposed and faces upward. It should be noted that the determination may be performed in the input apparatus 3, or in the information processing apparatus 2, which receives information about the result of detection of reflected light from the input apparatus 3.

In addition, in another example, in the case in which the input apparatus 3 includes a distance measurement sensor capable of detecting a distance between the bottom surface of the input apparatus 3 and the placement surface, it may be determined whether the upside-down orientation operation has been performed, using the distance calculated based on the result of detection by the distance measurement sensor.

In this embodiment, in the upside-down orientation operation using the input apparatus 3, an operation of moving a predetermined object such as a portion of the body of the user (e.g., a finger) along the exposed bottom surface of the input apparatus 3 can be performed. For example, even when the bottom surface, in which the light guide path linked to the mouse sensor 34 is open, is exposed upward, if the user's finger is over and close to the aperture as an object to be detected, the result indicating that the object to be detected has been detected can be output. As an example, the mouse sensor 34 outputs data even when the bottom surface is exposed upward, the result indicating that the object to be detected has been detected is output by the data indicating that the intensity of the reflected light is at least a predetermined threshold. It should be noted that the data output by the mouse sensor 34 with the bottom surface exposed upward may be other data that is not associated with the intensity of the reflected light. As another example, the mouse sensor 34 may not output data when the object to be detected is not detected with the bottom surface exposed upward, and may output the result indicating that the object to be detected has been detected, by the data output when reflected light from the object to be detected is detected. In addition, the mouse sensor 34 can calculate a parameter related to the movement of the object to be detected along the bottom surface of the input apparatus 3 (e.g., the movement direction and movement distance of the object to be detected). As an example, as shown in FIG. 3, when the user's finger moves over the aperture for the mouse sensor 34, the movement direction and movement distance of the moved finger can be calculated.

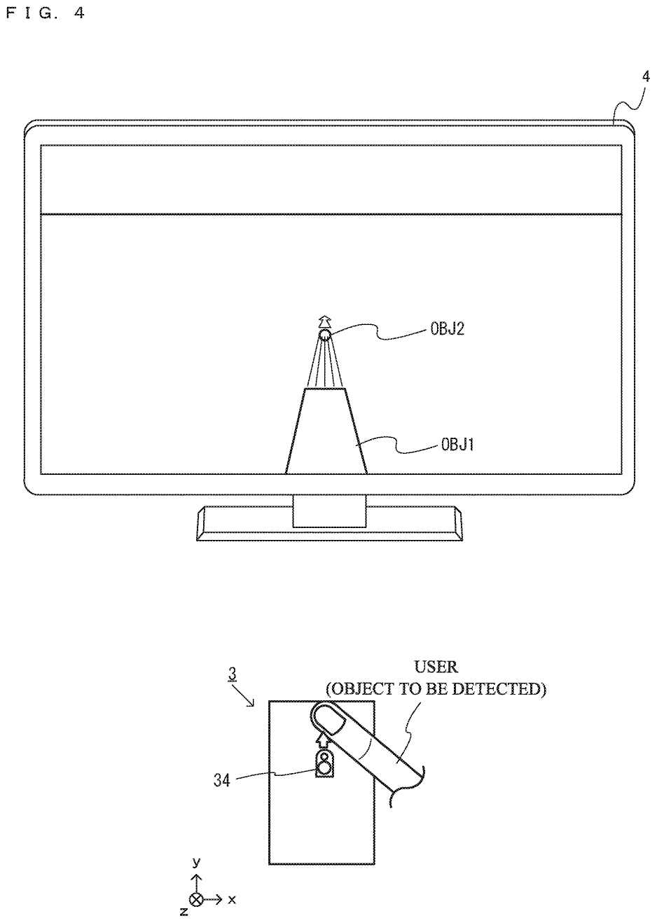

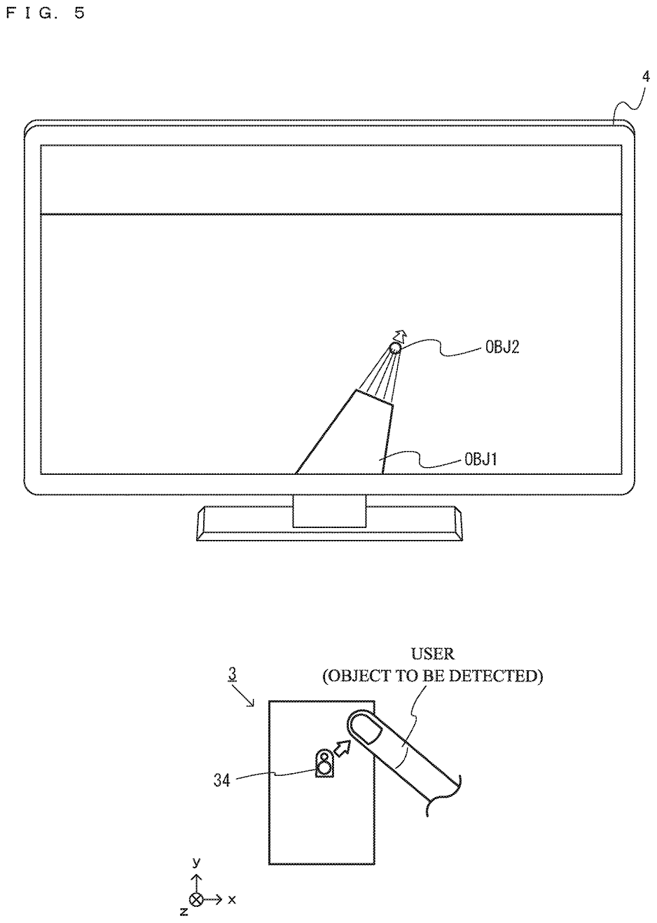

Next, an example of a game process in the first embodiment will be outlined with reference to FIGS. 4 and 5. Although in the following description, a game is used as an example of an application that is executed in the information processing apparatus 2, other applications may be executed in the information processing apparatus 2.

In FIG. 4, in the above example game process, a first object OBJ1 and a second object OBJ2 in a virtual space that are displayed on the display apparatus 4 are operated according to the upside-down orientation operation input to the input apparatus 3. For example, in the example game process, executed is a process of changing the orientation of the first object OBJ1 to a direction in the virtual space corresponding to a movement operation direction in the upside-down orientation operation of the input apparatus 3, and moving the second object OBJ2 in a direction based on the orientation of the first object OBJ1 at a movement speed corresponding to a movement operation speed in the upside-down orientation operation.

For example, in the upside-down orientation operation of the input apparatus 3 shown in FIG. 4, the input apparatus 3 is held by the user in an orientation in which the bottom surface of the input apparatus 3 facing upward and the front surface of the input apparatus 3 facing forward (e.g., the positive direction of the z-axis points in the gravitational direction of the real world, and the positive direction of the y-axis points in the forward direction). The user is performing the upside-down orientation operation in which a finger is moved forward over the aperture for the mouse sensor 34 along the bottom surface of the input apparatus 3 (e.g., an operation of moving a finger in the positive direction of the y-axis along the bottom surface) (an operation in the direction indicated by the arrow in FIG. 4).

When the operation of sliding a finger forward over the aperture is thus operated, the information processing apparatus 2 calculates the movement operation direction toward the front of the input apparatus 3 (the positive direction of the y-axis) and the movement operation speed based on the amount of movement per unit time of the slid finger. In the example game process, when the state in which the mouse sensor 34 has not detected an object to be detected is changed to the state in which the mouse sensor 34 has detected an object to be detected (e.g., the state in which a finger has not reached the aperture is changed to the state in which a finger has started to cover a portion of the aperture), the orientation of the first object OBJ1 is changed such that the first object OBJ1 faces in a direction in the virtual space corresponding to the calculated movement operation direction. In the example of FIG. 4, the movement operation direction toward the front of the input apparatus 3 (the positive direction of the y-axis) has been calculated, and therefore, the orientation of the first object OBJ1 is adjusted such that the first object OBJ1 faces in the forward direction of the virtual space corresponding to the movement operation direction (e.g., the line-of-sight direction of a virtual camera for generating a virtual space image). Thereafter, in the example game process, when the state in which the mouse sensor 34 has detected an object to be detected is changed to the state in which the mouse sensor 34 has not detected an object to be detected (e.g., the state in which a finger covers a portion of the aperture is changed to the state in which a finger does not cover the aperture at all after having passed over the aperture), the second object OBJ2 is shot to come out from a tip end of the first object OBJ1 in a movement direction based on the orientation of the first object OBJ1 at a movement speed corresponding to the calculated movement operation speed, and starts to move in the virtual space.

Meanwhile, in the upside-down orientation operation of the input apparatus 3 shown in FIG. 5, the user holds the input apparatus 3 in the same orientation as that shown in FIG. 4. The user is performing the upside-down orientation operation in which a finger is moved along the bottom surface of the input apparatus 3 over the aperture for the mouse sensor 34 in a diagonally forward and rightward direction (e.g., an operation of moving a finger along the bottom surface in the direction that is diagonal at 45° from the positive direction of the y-axis toward the positive direction of x-axis) (an operation in the direction indicated by the arrow in FIG. 5).

By thus performing an operation of sliding a finger over the aperture in a diagonally forward and rightward direction, the orientation of the first object OBJ1 is adjusted such that the first object OBJ1 faces in a front right direction in the virtual space (e.g., the direction that is diagonal at 45° to the right from the line-of-sight direction of the virtual camera) corresponding to the movement operation direction toward the calculated diagonally forward and rightward direction (the direction that is diagonal at 45° from the positive direction of the y-axis toward the positive direction of the x-axis). Thereafter, in the example of FIG. 5, the second object OBJ2 is shot in a movement direction based on the orientation of the first object OBJ1 at a movement speed corresponding to the calculated movement operation speed.

Thus, in the example game process, the upside-down orientation operation of the input apparatus 3 is detected based on the orientation of the input apparatus 3 based on the result of detection by the inertial sensor, or the output of the mouse sensor 34. When the input apparatus 3 is in the upside-down orientation operation, the orientation of the first object OBJ1 in the virtual space is controlled based on the direction in which an object to be detected is slid in contact with the bottom surface of the input apparatus 3, and the second object OBJ2 is moved at a movement speed based on the amount of movement of the slid object to be detected in a movement direction based on the direction in which the object to be detected is slid.

It should be noted that in the case in which a movement operation direction that is a diagonally forward and rightward direction in the upside-down orientation operation shown in FIG. 5 is expressed in terms of the upward, downward, leftward, rightward, forward, and backward directions defined for the input apparatus 3 in this embodiment, the movement operation direction is a diagonally forward and leftward direction of the input apparatus 3. In addition, in the case in which a movement operation direction that is a diagonally forward and leftward direction in the upside-down orientation operation shown in FIG. 5 is expressed in terms of the upward, downward, leftward, rightward, forward, and backward directions defined for the input apparatus 3 in this embodiment, the movement operation direction is a diagonally forward and rightward direction of the input apparatus 3. Thus, in the example game process, in the upside-down orientation operation, a rightward operation instruction and a leftward operation instruction in the virtual space correspond to a leftward operation direction and a rightward operation direction, respectively, that are defined when the input apparatus 3 is in the normal operation orientation in which the bottom surface of the input apparatus 3 is placed on the placement surface. Therefore, in the example game process, the left-right direction of the input apparatus 3 in the upside-down orientation operation orientation is reversed with respect to that in the normal operation orientation in the virtual space. Since the left-right direction is thus reversed, operation instructions can be intuitively made in intended directions in the virtual space during the upside-down orientation operation.

In the example game process, the direction in which the first object OBJ1 is oriented is set to an angle deviating leftward or rightward with respect to the forward direction in the virtual space as a reference direction, corresponding to the angle of the movement operation direction of the input apparatus 3 deviating leftward or rightward. In another example, the movement operation direction may be calculated, taking into account a change caused by the direction in which an object to be detected is slid in contact with the bottom surface of the input apparatus 3, and in addition, a change caused by the orientation of the input apparatus 3. For example, the reference direction in the virtual space may be changed based on the orientation of the input apparatus 3 calculated based on the result of detection by the inertial sensor.

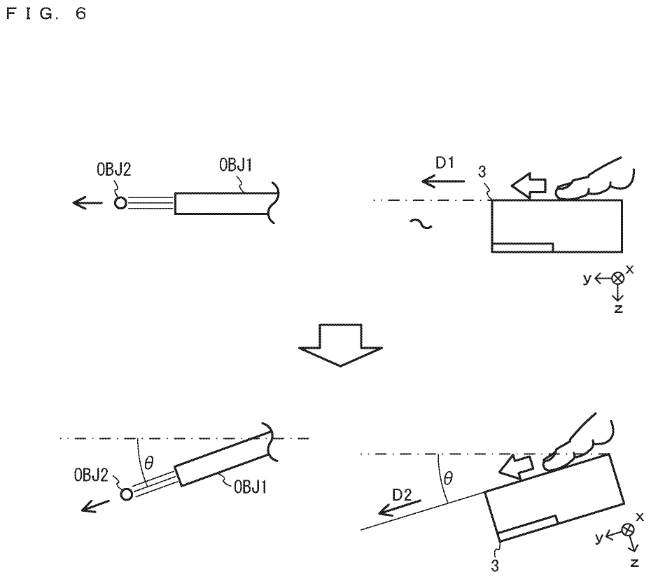

As shown in FIG. 6, the reference direction in the virtual space may be changed in the top-bottom direction according to a change in the orientation in the pitch direction of the input apparatus 3 when the input apparatus 3 is being in the upside-down orientation operation. For example, as shown in the upper diagram of FIG. 6, when the input apparatus 3 is in an orientation in which the bottom surface of the input apparatus 3 is horizontal in the real world (e.g., both the x-axial direction and y-axial direction of the input apparatus 3 are horizontal), the reference direction is set to the horizontal direction in the virtual space. When in this state, an operation of sliding a finger in contact with the bottom surface of the input apparatus 3 is performed, a horizontal movement operation direction is provided which deviates from the reference direction in the left-right direction of the virtual space by an angle by which the movement operation direction D1 of the slid finger deviates in the left-right direction of the input apparatus 3.

Meanwhile, as shown in the lower diagram of FIG. 6, when the input apparatus 3 is in an orientation in which the bottom surface of the input apparatus 3 is tilted from the horizontal direction in the pitch direction in the real world (e.g., the bottom surface is tilted forward and downward at an angle of θ, the positive direction of the y-axis of the input apparatus 3 is tilted diagonally downward at an angle of θ), the reference direction is set to a direction tilted in the pitch direction in the virtual space (e.g., a depression angle direction with respect to the horizontal direction of the virtual space). As an example, in the case in which the reference direction is changed by the same angle as that of a change in the orientation of the input apparatus 3, when the input apparatus 3 is in an orientation in which the forward direction (the positive direction of the y-axis) of the input apparatus 3 is tilted downward by an angle of θ, the reference direction is set to a direction that points downward by a depression angle of θ in the virtual space. When in this state, an operation of sliding a finger in contact with the bottom surface of the input apparatus 3 is performed, a movement operation direction is provided which points in a depression angle direction that deviates in the left-right direction of the virtual space with reference to the reference direction by an angle by which the movement operation direction D2 of the slid finger deviates in the left-right direction of the input apparatus 3.

It should be noted that a change in the movement operation direction due to the orientation of the input apparatus 3 is not limited to a change in the pitch direction. The reference direction may be set based on not only a change in the pitch direction but also a change in the yaw direction and roll direction in the real world.

In addition, a direction in the virtual space based on the direction in which an object to be detected is slid in contact with the bottom surface of the input apparatus 3, and a direction in the virtual space based on the orientation of the input apparatus 3, may be controlled so as to produce an influence on different parameters. As an example, the initial movement direction of the second object OBJ2 during the start of movement may be controlled according to the orientation of the first object OBJ1, by changing the orientation of the first object OBJ1 based on the direction in the virtual space based on the orientation of the input apparatus 3, while the movement direction of the second object OBJ2 may be changed and bent after the start of the movement, based on the direction in the virtual space based on the direction in which an object to be detected is slid. As a second example, the initial movement direction of the second object OBJ2 during the start of movement may be controlled according to the orientation of the first object OBJ1, by changing the orientation of the first object OBJ1 based on the direction in the virtual space based on the direction in which an object to be detected is slid, while the movement direction of the second object OBJ2 may be changed and bent after the start of the movement, based on the direction in the virtual space based on the orientation of the input apparatus 3.

In addition, in another example, in the example game process, the motions of the first object OBJ1 and the second object OBJ2 may be controlled by not only the upside-down orientation operation but also an operation in the normal orientation in which the input apparatus 3 is operated with the bottom surface of the input apparatus 3 placed on the placement surface (referred to as a “normal orientation operation”).

As an example, the orientation of the first object OBJ1 may be changed according to the movement and orientation of the input apparatus 3 on the placement surface, and the second object OBJ2 may be shot according to an operation performed on the operation button 31. Although in the upside-down orientation operation, the movement operation direction and the direction in the virtual space are reversed in terms of the left-right direction, the movement operation direction and the direction in the virtual space may be normally associated with each other in the normal orientation operation.

In addition, this embodiment may be applied to a game in which a bow is drawn in a direction corresponding to the movement operation direction in which an object to be detected is slid, and an arrow flies in the opposite direction. Alternatively, this embodiment may be applied to a game in which a bow is drawn in a direction opposite to the movement operation direction in which an object to be detected is slid, and an arrow flies in a direction corresponding to the movement operation direction. Furthermore, an arrow may be nocked based on the movement operation direction, and the nocked arrow may be shot according to an operation performed on the operation button 31.

In addition, this embodiment may be applied to an information process in which in the virtual space in which a plurality of options are displayed, a cursor may be moved in the calculated movement operation direction, so that an option displayed in that direction is selected.

As a fourth example, a position may be set in the virtual space based on the orientation of the input apparatus 3, and a predetermined process may be executed in relation to the set position when an object to be detected is detected.

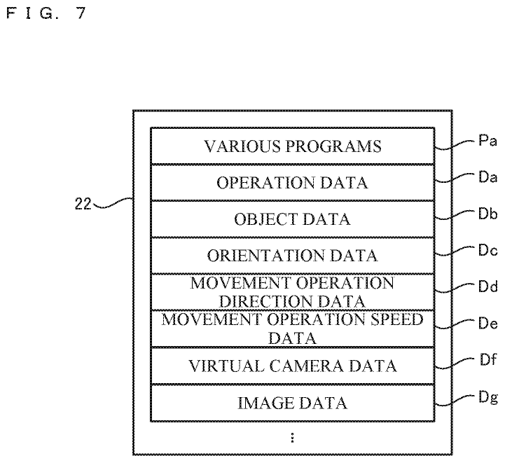

Next, processes executed in the information processing apparatus 2 of the first embodiment will be described in detail. Firstly, main data used in the processes executed in the information processing apparatus 2 will be described with reference to FIG. 7.

As shown in FIG. 7, the data storage area of the storage unit 22 stores operation data Da, object data Db, orientation data Dc, movement operation direction data Dd, movement operation speed data De, virtual camera data Df, image data Dg, and the like. It should be noted that the storage unit 22 stores data needed in processes such as data used in an executed application, in addition to the data shown in FIG. 7. In addition, the program storage area of the storage unit 22 stores various programs Pa included in an information processing program (game program) and the like.

The operation data Da indicates operation information about an operation performed on the input apparatus 3 by the user. For example, operation data indicating that the input apparatus 3 has been operated (data indicating operations performed on the operation buttons 31 and 32, and data based on the result of detection in the mouse sensor 34) is acquired for each unit time (e.g., 1/60 seconds) for which the information processing apparatus 2 executes a process, and is stored into the operation data Da in response to the acquisition, so that the operation data Da is updated. In addition, operation data detected by an inertial sensor (the angular velocity sensor 36, the acceleration sensor 37) operated by moving the input apparatus 3 is also acquired for each unit time (e.g., 1/60 seconds) in which the information processing apparatus 2 executes a process, and is stored into the operation data Da in response to the acquisition, so that the operation data Da is updated.

The object data Db indicates the position, orientation, motion, state, display form, and the like of an object displayed on the display apparatus 4 (e.g., the first object OBJ1, the second object OBJ2).

The orientation data Dc indicates the orientation of the input apparatus 3 in the real world, and a reference direction set in the virtual space based on the orientation of the input apparatus 3.

The movement operation direction data Dd indicates a movement operation direction calculated based on the movement direction of an object to be detected that has been slid in contact with the bottom surface of the input apparatus 3 and the orientation of the input apparatus 3. The movement operation speed data De indicates a movement operation speed calculated based on the amount of movement in which an object to be detected has been slid in contact with the bottom surface of the input apparatus 3.

The virtual camera data Df indicates the position, orientation, and the like of a virtual camera.

The image data Dg is for displaying an image of the virtual space on the display apparatus 4.

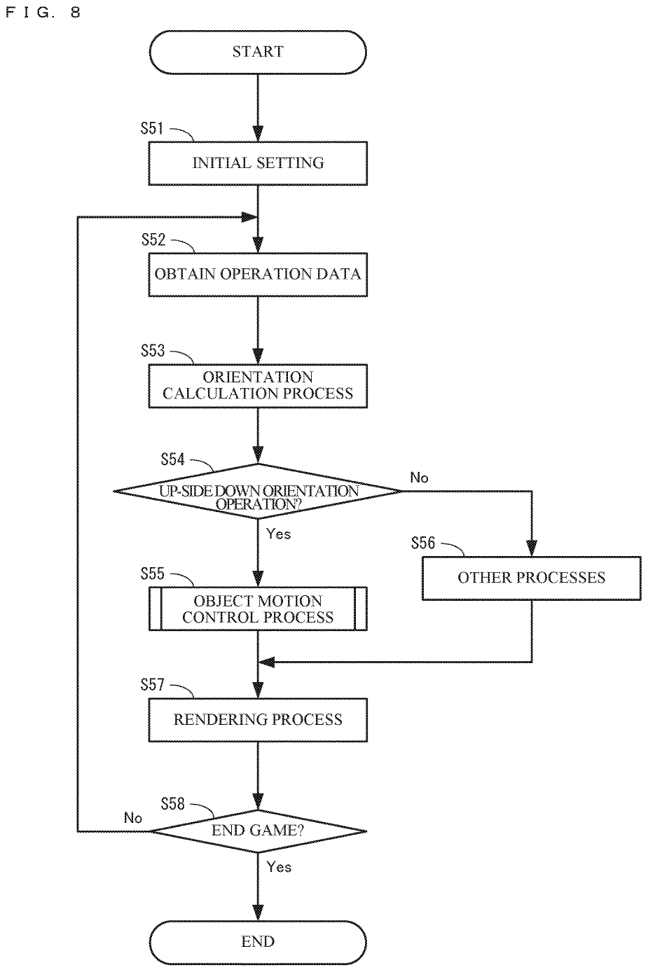

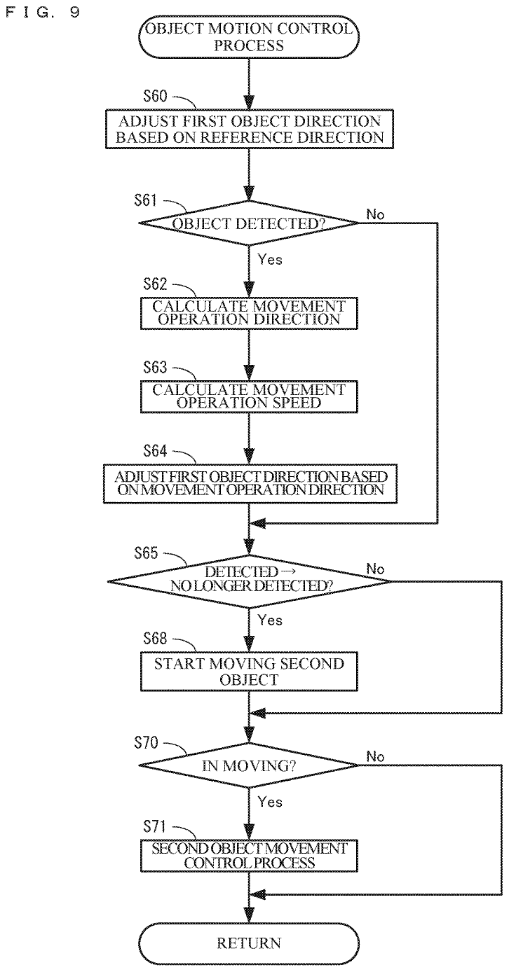

Next, processes executed in the information processing apparatus 2 of the first embodiment will be described in detail with reference to FIGS. 8 and 9.

In the present example, a series of processes shown in FIGS. 8 and 9 is executed by the control unit 21 (CPU) executing a game program or the like stored in the program storage unit 23.

The steps in the flowcharts shown in FIGS. 8 and 9 are merely illustrative. All or a portion of the steps of the flowcharts may be executed by another processor or a dedicated circuit instead of the CPU of the control unit 21.

In FIG. 8, the control unit 21 sets initial settings (step S51), and proceeds to the next step.

Next, the control unit 21 obtains operation data from the input apparatus 3 and updates the operation data Da (step S52), and proceeds to the next step.

Next, the control unit 21 executes an orientation calculation process (step S53), and proceeds to the next step. For example, the control unit 21 refers to the operation data Da to obtain detection result data output by an inertial sensor (the angular velocity sensor 35 and the acceleration sensor 36), calculates the orientation of the input apparatus 3 in the real world based on the detection result data, and updates the orientation data Dc.

Next, the control unit 21 determines whether the input apparatus 3 is being in the upside-down orientation operation (step S54). For example, the control unit 21 refers to the orientation data Dc, and if the orientation data Dc indicates that the upward direction of the input apparatus 3 (the positive direction of the z-axis) is within a predetermined range covering the downward direction of the real world (e.g., a predetermined angular range with reference to the gravitational direction), the result of the determination in step S54 is positive.

In step S55, the control unit 21 executes an object motion control process, and proceeds to step S57. The object motion control process of step S55 will be described below with reference to FIG. 9.

In FIG. 9, the control unit 21 adjusts the direction of the first object OBJ1 based on the reference direction (step S60), and proceeds to the next step. For example, the control unit 21 refers to the orientation data Dc, and sets a direction in the virtual space corresponding to the direction in which the forward direction (the positive direction of the y-axis) of an input apparatus points, as the reference direction. Thereafter, the control unit 21 adjusts the direction of the first object OBJ1 such that the first object OBJ1 faces in the reference direction of the virtual space, and updates the object data Db.

Next, the control unit 21 determines whether the mouse sensor 34 has detected an object (step S61). For example, the control unit 21 refers to the operation data Da, and if the operation data Da indicates that the mouse sensor 34 has output a detection result indicating that the mouse sensor 34 has detected reflected light from an object to be detected, the result of the determination in step S61 is positive.

In step S62, the control unit 21 calculates the movement operation direction, updates the movement operation direction data Dd, and proceeds to the next step.

Next, the control unit 21 calculates the movement operation speed and updates the movement operation speed data De (step S63), and proceeds to the next step.

Next, the control unit 21 adjusts the direction of the first object OBJ1 based on the movement operation direction (step S64), and proceeds to step S65. For example, the control unit 21 calculates the difference in angle between the movement operation direction calculated in step S62 and the forward direction (the positive direction of the y-axis) of the input apparatus 3, adjusts the direction of the first object OBJ1 such that the first object OBJ1 faces in a direction in the virtual space that deviates from the reference direction set in step S60 in the same direction by the angular difference, and updates the object data Db. It should be noted that the object data Db may be updated with a direction corresponding to the calculated movement operation direction, or with a direction that is closer to the direction corresponding to the calculated movement operation direction compared to the current object data Db.

In step S65, the control unit 21 determines whether the state in which the mouse sensor 34 is detecting an object has been changed to the state in which the mouse sensor 34 is not detecting an object.

In step S68, the control unit 21 starts moving the second object OBJ2 based on the direction of the first object OBJ1 and the movement operation speed, updates the object data Db, and ends the subroutine.

In step S70, the control unit 21 determines whether the second object OBJ2 is moving in the virtual space.

In step S71, the control unit 21 executes a second object movement control process, and ends the subroutine. For example, the control unit 21 moves the second object OBJ2 based on the position, movement direction, and movement speed of the second object OBJ2 indicated by the object data Db, and physical calculation in the virtual space, and updates the object data Db using the position, movement direction, and movement speed of the second object OBJ2 after the movement.

Referring back to FIG. 8, if in step S54, the control unit 21 determines that the upside-down orientation operation is not being performed, the control unit 21 executes another process (step S56), and proceeds to step S57. As an example, if the normal orientation operation is being performed, in which the input apparatus 3 is moved on the placement surface with the bottom surface thereof placed on the placement surface, the control unit 21 executes a process according to data output from the input apparatus 3 by the normal orientation operation. It should be noted that in step S56, the motions of the first object OBJ1 and/or the second object OBJ2 can be controlled by the normal orientation operation as described above, and the motion control may be performed as the other process.

In step S57, the control unit 21 executes a rendering process, and proceeds to the next step.

Next, the control unit 21 determines whether to end the game process (step S58).

Thus, in the information processing system 1a of the first embodiment, it is determined whether the input apparatus 3, which has the mouse function, is in an orientation in which the upside-down orientation operation is being performed, and if the input apparatus 3 is in such an orientation, then when an object to be detected is positioned close to the aperture forming the light guide path of the mouse sensor 34, the motion of an object is controlled. Therefore, novel operation experience and amusingness can be provided in terms of the operation of the input apparatus 3.

### Second Embodiment

An information processing system 1b according to a second embodiment will be described. The information processing system 1b is constructed such that an input apparatus 9 is connected to an information processing apparatus 2 wirelessly or by a cable instead of the input apparatus 3 of the information processing system 1a of the first embodiment. The information processing apparatus 2 and a display apparatus 4 of the second embodiment are similar to those of the first embodiment, and therefore, are indicated by the same reference characters and will not be described in detail.

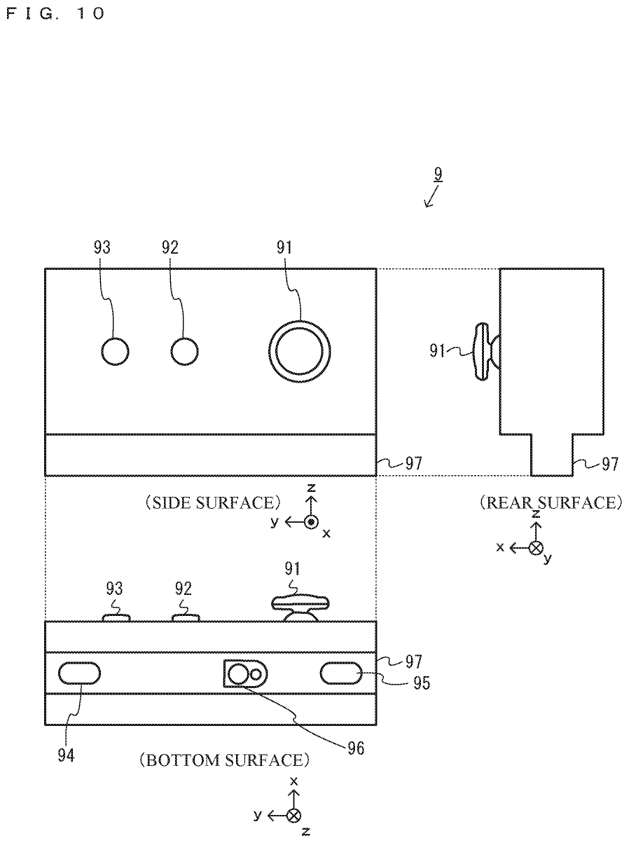

As shown in FIG. 10, the input apparatus 9 has the mouse function as with the input apparatus 3.

In the second embodiment, the input apparatus 9 is in the shape of a controller (e.g., a game controller) that is lifted and held by one or both hands of the user. For example, the input apparatus 9 has a housing that is in the shape of generally a rectangular cuboid and that can be held by one or both hands of the user. For example, the input apparatus 9 shown in FIG. 10 includes an analog stick 91 and operation buttons 92 and 93 on one side surface of the housing. The analog stick 91 is provided at a portion of the side surface closer to a rear surface of the input apparatus 9 and can be used as a direction input unit capable of inputting a direction. The user can tilt the analog stick 91 to input a direction corresponding to the tilt direction (and a magnitude corresponding to the tilt angle). It should be noted that the input apparatus 9 may include a directional pad or a slide stick that can be slid to input a direction, as the direction input unit, instead of the analog stick. In addition, in this embodiment, the analog stick 91 can be pressed down to provide an input. The operation buttons 91 and 92 are arranged side by side on the side surface in front of the analog stick 91, and are configured to be able to be pressed down from one side surface to the other side surface. In addition, the input apparatus 9 may include other input means as with the input apparatus 3, and may be removably attached to the information processing apparatus 2 or the display apparatus 4. Two input apparatuses 9 (e.g., the input apparatuses 9 may have different shapes) may be removably attached to the information processing apparatus 2 or the display apparatus 4,

A protrusion portion 97 having a rectangular cuboid shape is provided on the bottom surface of the input apparatus 9 at a center thereof. The front-back direction of the protrusion portion 97 is the longitudinal direction of the protrusion portion 97. The protrusion portion 97 serves as an attachment that allows the input apparatus 9 to be removably inserted and attached to another apparatus such as a game body apparatus. For example, the protrusion portion 97 may have an appropriate mechanism such as a mechanical structure or magnetic force that allows the input apparatus 9 to be removably attached to another apparatus. The protrusion portion 97 may be formed, extending across the bottom surface of the input apparatus 9 in the longitudinal direction, or at a portion excluding both ends of the bottom surface of the input apparatus 9.

Operation buttons 94 and 95 are provided on the apex surface of the protrusion portion 97 (the lowermost bottom surface of the input apparatus 9). An aperture for the mouse sensor 96 is formed at a position between the operation button 94 and the operation button 95. The operation buttons 94 and 95 are provided near the front end and rear end, respectively, of the apex surface of the protrusion portion 97, and are configured to be able to be pressed in the direction from the bottom surface to the top surface. The press surfaces of the operation buttons 94 and 95 are positioned at the same level as (flush with) the apex surface of the protrusion portion 97 or a level lower than (embedded in) the apex surface of the protrusion portion 97 so that the operation buttons 94 and 95 are not pressed down when the apex surface of the protrusion portion 97 is brought into contact with the placement surface, or when the input apparatus 9 is attached to another apparatus,

The input apparatus 9 includes a mouse sensor 96 in order to carry out the mouse function. The mouse sensor 96 may have a configuration similar to that of the mouse sensor 34. In addition, the aperture for the mouse sensor 96 is formed closer to the operation button 95 in the longitudinal direction (front-back direction) of the apex surface of the protrusion portion 97, or alternatively, may be formed at a middle between the operation buttons 94 and 95. It should be noted that data output from the mouse sensor 96 may be dealt with in a manner similar to that for the output data of the mouse sensor 34.

In this embodiment, in order to make it easier to understand the directions of the input apparatus 9, the front-back direction is defined as the longitudinal direction of the side or bottom surface of the input apparatus 9, the left-right direction is defined as the transverse direction of the bottom surface of the input apparatus 9 perpendicular to the side surface, and the top-bottom direction is defined as the direction perpendicular to the bottom surface of the input apparatus 9. In addition, three axial directions (x-, y-, and z-axial directions) are defined with respect to the input apparatus 9 as indicated in FIG. 10.

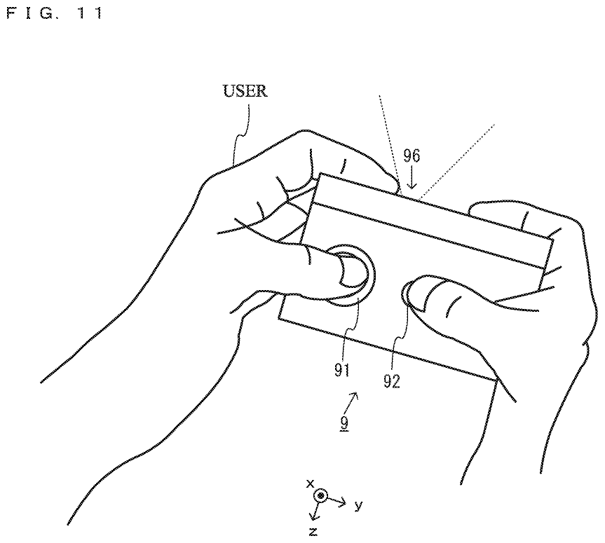

As shown in FIG. 11, in the present example, a process can be executed based on the user's operation of lifting the input apparatus 9 from the placement surface and holding the input apparatus 9 with the longitudinal direction thereof pointing in the left-right direction of the user (hereinafter referred to as a “landscape holding operation”). In the landscape holding operation, the input apparatus 9 is operated in an orientation in which the bottom surface of the input apparatus 9 faces forward or upward with respect to the user, the side surface of the input apparatus 9 on which the analog stick 91 is provided faces upward or toward the user, the front surface side of the input apparatus 9 is held by the right hand, and the rear surface side of the input apparatus 9 is held by the left hand.

The technique for determining whether the input apparatus 9 is being in the landscape holding operation is not particularly limited. In a first example when both of the operation buttons 94 and 95 are simultaneously pressed down, it may be determined that the input apparatus 9 is being in the landscape holding operation. It should be noted that after it is determined that the input apparatus 9 is being in the landscape holding operation, even when the operation of pressing down the operation buttons 94 and 95 is no longer performed, it may continue to be determined that the input apparatus 9 is being in the landscape holding operation. In addition, after it is determined that the input apparatus 9 is being in the landscape holding operation, even when the bottom surface of the input apparatus 3 is placed on the placement surface, it may continue to be determined that the input apparatus 9 is being in the landscape holding operation. In addition, in a second example, based on an output indicating that the mouse sensor 96 can no longer detect reflected light appropriately, it may be determined that the input apparatus 9 is being in the landscape holding operation. In addition, in a third example, based on the result of detection by an inertial sensor included in the input apparatus 9, it may be determined that the input apparatus 9 is being in the landscape holding operation. It should be noted that as an example, the techniques described in the first to third examples may be combined as appropriate.

The result of the determination indicating that the input apparatus 9 is being in the landscape holding operation may not necessarily indicate that the input apparatus 9 is actually being held and operated in a landscape orientation. Based on the result of the determination indicating that the input apparatus 9 is being in the landscape holding operation, a predetermined process is executed in response to a predetermined input in a game process.

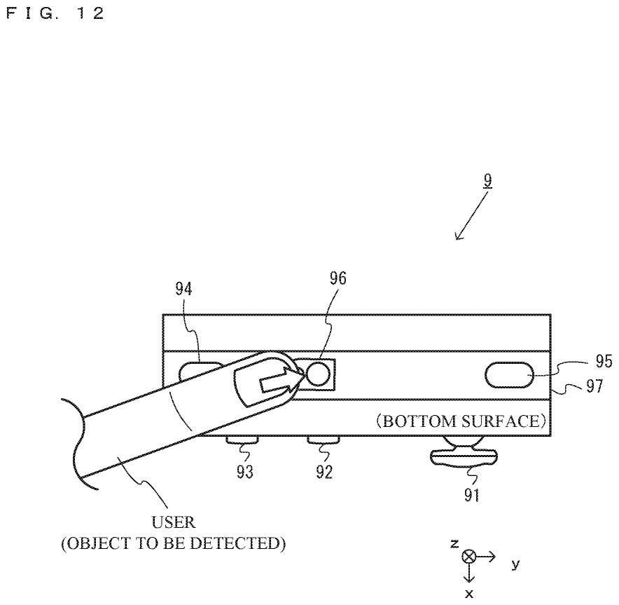

In this embodiment, in the landscape holding operation using the input apparatus 9, the analog stick 91 and the operation buttons 92 and 93 provided on the side surface of the input apparatus 9, and the operation buttons 94 and 95 provided on the bottom surface of the input apparatus 9, can be operated by the user using a finger or the like. In addition, in the landscape holding operation, an operation of blocking or opening the aperture for the mouse sensor 96 formed in the bottom surface of the input apparatus 9 with a portion (e.g., a finger) of the user's body, or moving a portion (e.g., a finger) of the user's body over the aperture, can be performed. As an example, as shown in FIG. 12, when the aperture for the mouse sensor 96 is blocked by the user's finger, the blocking finger is detected as an object to be detected as a result of detection.

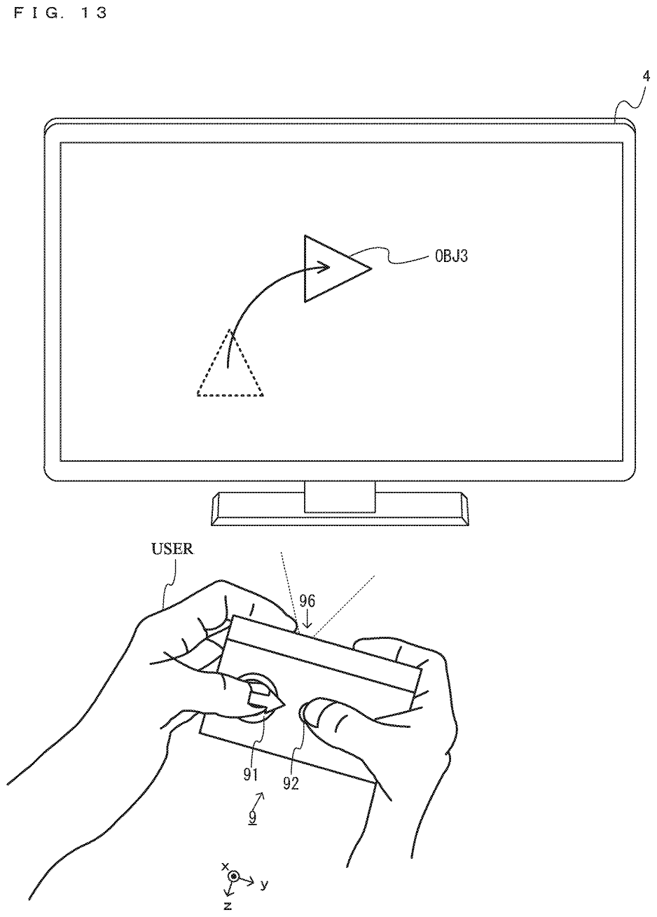

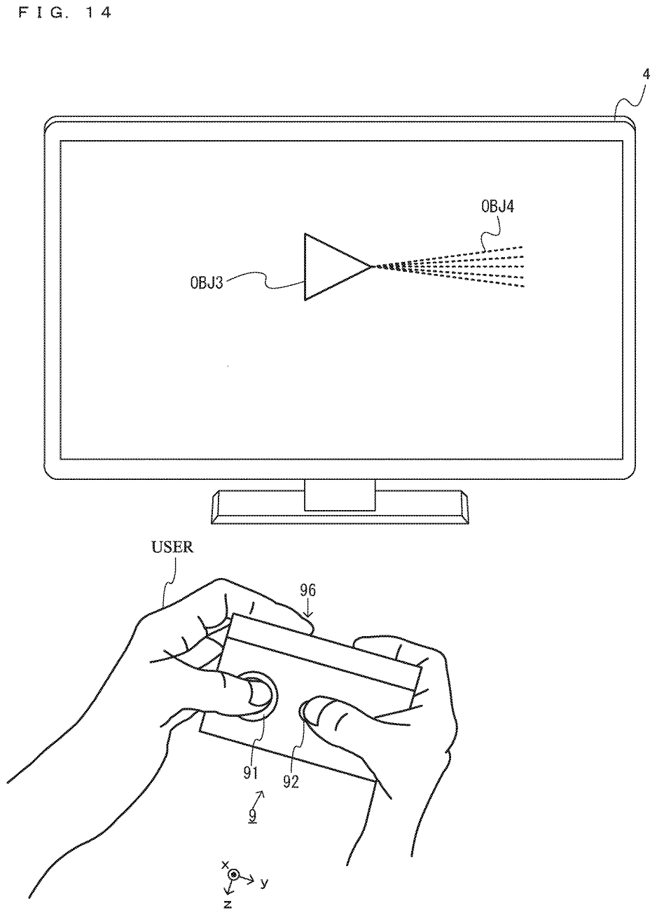

Next, an example of a game process in the second embodiment will be outlined with reference to FIGS. 13 and 14. Although in the following description, a game is used as an example of an application that is executed in the information processing apparatus 2, other applications may be executed in the information processing apparatus 2.

In FIG. 13, in the example game process, a third object OBJ3 is moved in the virtual space while changing the direction according to a direction instruction operation (e.g., an operation of tilting the analog stick 91) in the landscape holding operation of the input apparatus 9. In addition, an action of spraying a fourth object OBJ4 in a direction based on the orientation of the third object OBJ3 according to an operation of blocking the aperture in the landscape holding operation.

For example, in the landscape holding operation of the input apparatus 9 shown in FIG. 13, the user is performing the direction instruction operation of tilting the analog stick 91 using the thumb of the left hand, for example (operation in the direction indicated by the arrow in FIG. 13). In the information processing apparatus 2, when output data indicating the tilt direction and tilt amount is obtained from the analog stick 91 in response to the direction instruction operation, the orientation of the third object OBJ3 is changed according to a direction corresponding to the tilt direction, and the third object OBJ3 is moved in that direction at a speed corresponding to the tilt amount. In the example of FIG. 13, the direction instruction operation indicating the rightward direction (the positive direction of the y-axis) of the input apparatus 9 is performed, so that the third object OBJ3 is oriented in a rightward direction of the virtual space corresponding to the direction instruction operation (e.g., a rightward direction with respect to the line-of-sight direction of a virtual camera that generates a virtual space image), and is moved at a speed corresponding to the tilt amount. It should be noted that for example, when the analog stick 91 is tilted upward (the negative direction of the z-axis) in FIG. 13, the third object OBJ is oriented forward (upward in the display screen) in the virtual space and is moved forward. In the example game process, the direction of the third object OBJ3 is changed to a leftward or rightward direction in the virtual space according to a direction operation in a leftward or rightward direction in the landscape holding operation. In addition, the direction of the third object OBJ3 is changed to an upward direction in the display screen according to a direction operation in a forward direction (the negative direction of the z-axis) in the landscape holding operation. The direction of the third object OBJ3 is changed to a downward direction in the display screen according to a direction operation in a backward direction (the positive direction of the z-axis) in the landscape holding operation. It should be noted that in FIG. 13, the aperture for the mouse sensor 96 is open.

Meanwhile, in the landscape holding operation of the input apparatus 9 shown in FIG. 14, the user is performing an operation of blocking the aperture for the mouse sensor 96 using a finger (e.g., the index finger of the left hand). While the operation of blocking the aperture for the mouse sensor 96 is thus being performed, the fourth object OBJ4 is sprayed from the tip end of the third object OBJ3 in a movement direction based on the set direction of the third object OBJ3.

Thus, in the example game process, when the input apparatus 9 is being in the landscape holding operation, a fine direction input can be carried out using the analog stick 91 provided on the side surface of the input apparatus 9 as a direction input unit. In addition, the mouse sensor 96 can be used as an input means.

It should be noted that in the case in which the left-right direction (the direction of the y-axis) in the landscape holding operation shown in FIGS. 11 to 14 is expressed in terms of the upward, downward, leftward, rightward, forward, and backward directions defined for the input apparatus 9 in this embodiment, the left-right direction is the front-back direction of the input apparatus 9. In addition, in the case in which the forward direction (the negative direction of the z-axis) in the landscape holding operation is expressed in terms of the upward, downward, leftward, rightward, forward, and backward directions defined for the input apparatus 9 in this embodiment, the forward direction is the downward direction of the input apparatus 9. In the case in which the backward direction (the positive direction of the z-axis) in the landscape holding operation is expressed in terms of the upward, downward, leftward, rightward, forward, and backward directions defined for the input apparatus 9 in this embodiment, the backward direction is the upward direction of the input apparatus 9. Thus, in the example game process, when the input apparatus 9 is in the normal operation orientation in which the bottom surface of the input apparatus 9 is placed on the placement surface, an operation instruction in the front-back direction provides an operation instruction in the left-right direction in the virtual space. In addition, in the example game process, in the normal operation orientation, an operation instruction in the downward direction provides an operation instruction in the upward direction in the virtual space, and an operation instruction in the upward direction provides an operation instruction in the downward direction in the virtual space. Therefore, in the example game process, the front-back direction when the input apparatus 9 is in the normal operation orientation corresponds to the left-right direction in the landscape holding operation in the virtual space, and the top-bottom direction when the input apparatus 9 is in the normal operation orientation corresponds to the reversed top-down direction in the landscape holding operation in the virtual space. By such direction correspondence, operation instructions can be provided in the virtual space according to intuition in the landscape holding operation. It should be noted that the input directions of the input apparatus 9 may correspond to the upward, downward, leftward, and rightward directions with reference to an operation object (the third object OBJ3 in the second embodiment) instead of the upward, downward, leftward, and rightward directions in the virtual space.

It should be noted that the game process of the above example is merely illustrative. For example, only the position or orientation of the third object OBJ3 may be controlled according to an operation performed on the analog stick 91. In addition, when the aperture for the mouse sensor 96 is blocked, only one fourth object OBJ4 may be shot.

In addition, in another example, a game process may be executed based on the movement direction of a finger moved over the aperture for the mouse sensor 96. In that case, the movement of an object to be detected in the left-right direction (the direction of the y-axis) in the landscape holding operation shown in FIGS. 11 to 14 is associated with an operation instruction in the left-right direction in the virtual space. In the case in which the movement of an object to be detected in the left-right direction (the direction of the y-axis) in the landscape holding operation shown in FIGS. 11 to 14 is expressed in terms of the upward, downward, leftward, rightward, forward, and backward directions defined for the input apparatus 9 in this embodiment, the movement of the object to be detected is a movement in the front-back direction of the input apparatus 9. In addition, the movement of an object to be detected in the top-bottom direction (the direction of the x-axis) in the landscape holding operation can be associated with an operation instruction in the top-bottom direction or the front-back direction in the virtual space. In the case in which the movement of an object to be detected in the top-bottom direction (the direction of the x-axis) in the landscape holding operation is expressed in terms of the upward, downward, leftward, rightward, forward, and backward directions defined for the input apparatus 9 in this embodiment, the movement of the object to be detected is a movement in the left-right direction of the input apparatus 9. Furthermore, in the case in which a direction instruction operation unit is provided on one of the top surface, front surface, rear surface, and bottom surface of the input apparatus 9, a direction instruction in the top-bottom direction (the direction of the x-axis) in the landscape holding operation using the direction instruction operation unit as expressed in terms of the upward, downward, leftward, rightward, forward, and backward directions defined above, is a direction instruction in the left-right direction of the input apparatus 9. Thus, in another example, the left-right direction of the input apparatus 9 in the normal operation orientation corresponds to the top-bottom direction or the front-back direction in the landscape holding operation orientation in the virtual space. By such direction correspondence in the other example, operation instructions can be provided in the virtual space according to intuition in the landscape holding operation.

In addition, in another example, the orientation and movement direction of the third object OBJ3 may be determined, taking into account the orientation of the input apparatus 9 in addition to the direction instruction operation.

In addition, in another example, in the landscape holding operation, a game process may be executed in which the motion of an object is additionally controlled by an operation of pressing down the operation buttons 94 and/or 95 of the input apparatus 9. The process that is executed by operating the operation button 94 and the process that is executed by operating the operation button 95 may be the same or different. In that case, while the landscape holding operation is being performed with the input apparatus 9 held by both hands, exposing the aperture for the mouse sensor 96, an operation of pressing down the operation buttons 94 and 95, between which the aperture is interposed, can be performed using a finger of the right hand and a finger of the left hand. Thus, while the bottom surface of the input apparatus 9 is not in contact with the placement surface, the output of the mouse sensor 96 can be used for game control, and an operation of pressing down the operation buttons 94 and/or 95 can be performed because the two operation buttons 94 and 95 are provided on the bottom surface, in which the aperture for the mouse sensor 96 is formed. It should be noted that because the aperture is formed between the operation buttons 94 and 95, the user can be prevented from blocking the aperture accidentally in the operation of pressing down the operation button 94 or 95.

In addition, the aperture for the mouse sensor 96 is formed closer to the operation button 95 in the longitudinal direction (front-back direction) of the apex surface of the protrusion portion 97. It is assumed that such an arrangement causes the user to perform the operation of pressing down the operation button 95 and the operation of blocking the aperture using the same finger. Therefore, in a game process in which operations performed on the operation buttons 94 and 95 are further used, when output data caused by the operation of pressing down the operation button 95 and output data caused by the operation of blocking the aperture are simultaneously obtained from the input apparatus 9, only one (e.g., only the earlier one) or none of control based on the operation of pressing down the operation button 95 and control based on the operation of blocking the aperture may be performed. Thus, the game process may not include a process in which both of the operation of pressing down the operation button 95 and the operation of blocking the aperture are required. Meanwhile, it is assumed that the operation of pressing down the operation button 94 and the operation of blocking the aperture are performed by different fingers of the user. Therefore, in a game process in which operations performed on the operation buttons 94 and 95 are further used, when output data caused by the operation of pressing down the operation button 94 and output data caused by the operation of blocking the aperture are simultaneously obtained from the input apparatus 9, both of control based on the operation of pressing down the operation button 94 and control based on the operation of blocking the aperture may be performed, or control different from these types of control may be performed, so that both of these types of operation can be simultaneously performed.

In addition, in another example, in the example game process, not only control of the motion of the third object OBJ3 based on the landscape holding operation, but also control of the motion of the third object OBJ3 based on an operation in a normal orientation in which the input apparatus 9 is operated with the bottom surface of the input apparatus 9 placed on the placement surface (referred to as a “normal orientation operation”) may be allowed. In that case, a game process corresponding to an operation performed in the landscape holding operation (e.g., an operation of tilting the analog stick 91, an operation of pressing down the operation buttons 92 to 95), and a game process corresponding to the operation performed in the normal orientation operation may be controlled in different manners. For example, in the information processing system 1b, the orientation and/or movement of the third object OBJ3 may be operated based on the result of detection output from the mouse sensor 96 instead of the operation of the analog stick 91. As an example, when in the landscape holding operation, an object is moved by a direction instruction operation performed by tilting the analog stick 91, the direction in which the object is to be moved is determined by the tilt direction, and the speed at which the object is to be moved is determined by the tilt amount. Meanwhile, when in the normal orientation operation, an object is moved by a direction instruction operation performed by moving the input apparatus 9 on the placement surface, the direction in which the object is to be moved is determined by the direction of the movement of the input apparatus 9, and the distance and speed over and at which the object is to be moved are determined by the amount of the movement of the input apparatus 9. In addition, at this time, a process different from the movement of an object or no process may be executed in response to the operation of the analog stick 91.

In addition, in another example, in the example game process, both of control of the motion of an object based on the landscape holding operation and control of the motion of an object based on the user's operation of holding the input apparatus 9 with the longitudinal direction thereof pointing in the front-back direction of the user (hereinafter referred to as a “portrait holding operation”) may be allowed. In the portrait holding operation, the input apparatus 9 is operated in an orientation in which the front surface of the input apparatus 9 faces in the forward direction of the user, the side surface of the input apparatus 9 on which the analog stick 91 is provided faces upward, the top surface side of the input apparatus 9 is held with the right hand, and the bottom surface side of the input apparatus 9 is held with the left hand. For example, in the information processing system 1b, it may be determined whether the input apparatus 9 is being in the landscape holding operation or the portrait holding operation, based on the orientation of the input apparatus 9 in the real world calculated based on the output of the inertial sensor of the input apparatus 9, or based on the pressing down of a predetermined operation button. When the input apparatus 9 is being in the portrait holding operation, an object may be controlled according to the operation of tilting the analog stick 91 or the operation of blocking the aperture for the mouse sensor 96. It should be noted that unlike the landscape holding operation, when the left-right direction (the direction of the z-axis) of the operation of tilting the analog stick 91 in the portrait holding operation is expressed in terms of the upward, downward, leftward, rightward, forward, and backward directions defined for the input apparatus 9 of this embodiment, the left-right direction is the top-bottom direction of the input apparatus 9. In addition, when the forward direction (the positive direction of the y-axis) in the portrait holding operation is expressed in terms of the upward, downward, leftward, rightward, forward, and backward directions defined for the input apparatus 9 of this embodiment, the forward direction is the forward direction of the input apparatus 9, and when the backward direction (the negative direction of the y-axis) in the portrait holding operation is expressed in terms of the upward, downward, leftward, rightward, forward, and backward directions defined for the input apparatus 9 of this embodiment, the backward direction is the backward direction of the input apparatus 9. Therefore, in this example, by associating the directions of the input apparatus 9 with different directions of the virtual space, depending on whether the input apparatus 9 is being in the landscape holding operation or the portrait holding operation, operation instructions can be provided in the virtual space according to intuition in each type of operation.

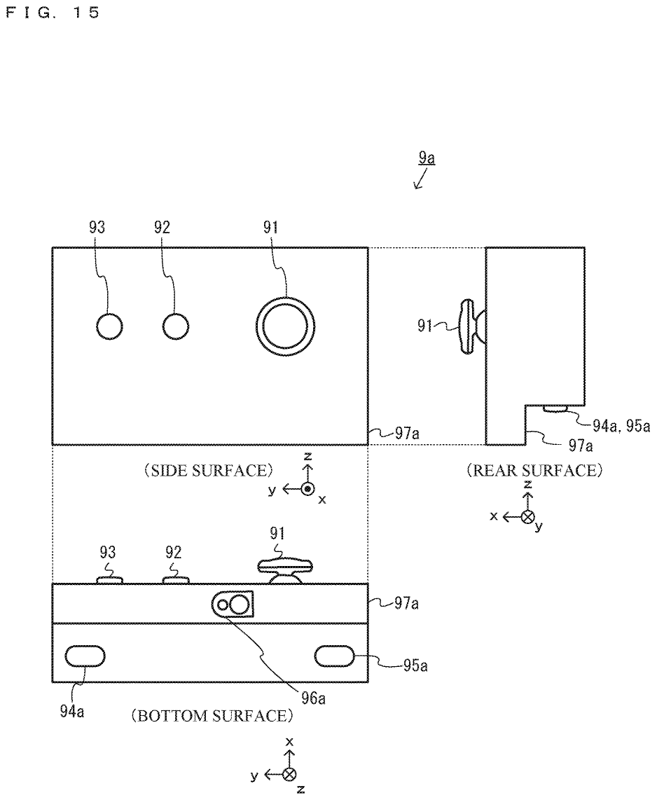

In addition, the input apparatus 9 may be other types of controllers. An input apparatus 9a that is another example used in the second embodiment will be described with reference to FIG. 15.

The input apparatus 9a is different from the input apparatus 9 in the shape of the bottom surface, and the positions where the aperture and the operation buttons are formed and provided on the bottom surface. On the bottom surface of the input apparatus 9a, a protrusion portion 97a that is in the shape of a rectangular cuboid whose front-back direction is a longitudinal direction is formed closer to one side surface (e.g., the side surface on which the analog stick 91 is provided). An aperture for a mouse sensor 96a is formed in the apex surface of the protrusion portion 97a (the lowermost bottom surface of the input apparatus 9a (downward: the negative direction of the z-axis)). In addition, operation buttons 94a and 95a are provided on a portion of the bottom surface of the input apparatus 9 where the protrusion portion 97a is not formed (specifically, a surface that is lower and closer to the top surface than the apex surface is (in the positive direction of the z-axis)). The operation buttons 94a and 95a are provided at an end of the above portion closer to the front surface and an end of the above portion closer to the rear surface such that the aperture is positioned between the operation buttons 94a and 95a in the longitudinal direction of the input apparatus 9a. It should be noted that the operation buttons 94a and 95a are not brought into contact with the placement surface when the bottom surface of the input apparatus 9a is brought into contact with the placement surface, and the input apparatus 9a is not configured to be attached to another apparatus, and therefore, the press surfaces of the operation buttons 94a and 95a may protrude from the above portion.

Next, processes executed in the information processing apparatus 2 of the second embodiment will be described in detail. In particular, differences from the processes shown in FIGS. 7 to 9 will be described below.

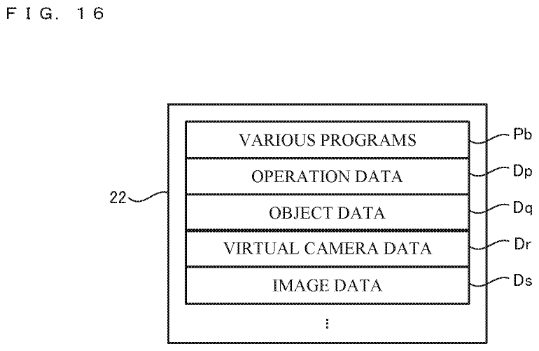

As shown in FIG. 16, the data storage area of the storage unit 22 stores operation data Dp, object data Dq, virtual camera data Dr, image data Ds, and the like. It should be noted that the program storage area of the storage unit 22 stores various programs Pa included in an information processing program (game program) or the like.

The operation data Dp indicates operation information about an operation performed on the input apparatus 9 by the user.

The object data Dq indicates the position, orientation, spray position, spray direction, display form, and the like of an object that is displayed on the display apparatus 4 (e.g., the third object OBJ3, the fourth object OBJ4).

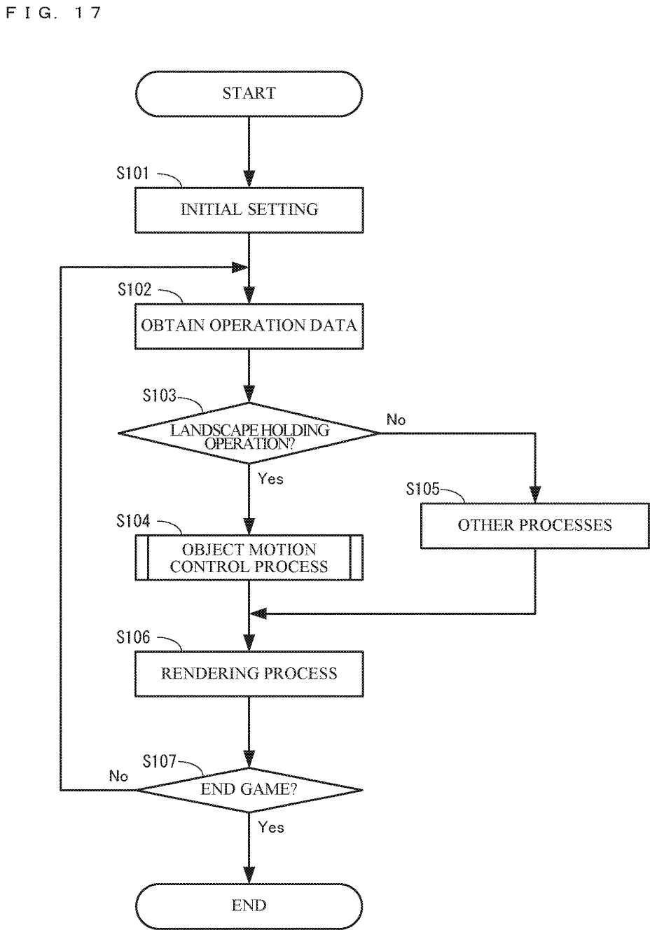

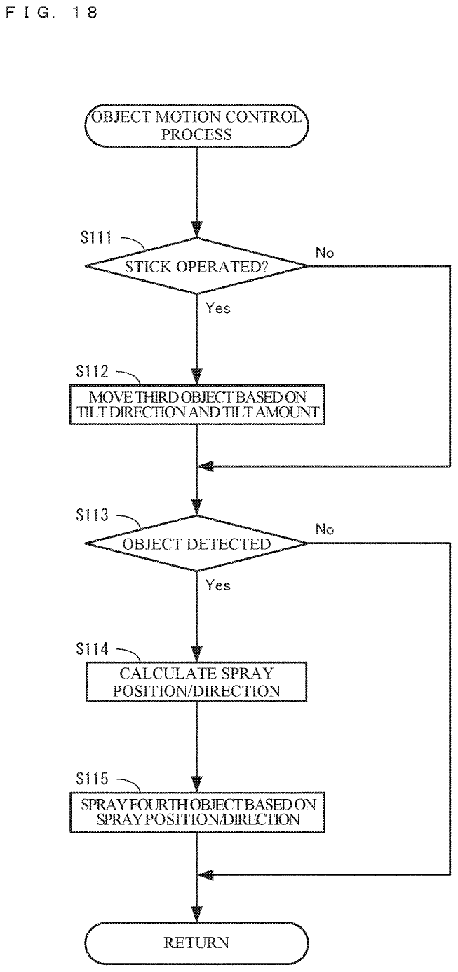

Next, processes executed in the information processing apparatus 2 of the second embodiment will be described with reference to FIGS. 17 and 18.

In FIG. 17, the control unit 21 sets initial settings (step S101), and proceeds to the next step. For example, the control unit 21 initially sets the third object OBJ3 at an initial position in the virtual space and in an initial orientation, and updates the object data Dq.

Next, the control unit 21 obtains operation data from the input apparatus 9 and updates the operation data Dp (step S102), and proceeds to the next step.

Next, the control unit 21 determines whether the input apparatus 9 is being in the landscape holding operation (step S103). It should be noted that the control unit 21 may maintain the result of the determination until it is determined that the input apparatus 9 is being operated in another orientation, in the process of step S103 that is executed after the result of the determination is positive.

In step S104, the control unit 21 executes an object motion control process, and proceeds to step S106. The object motion control process of step S104 will be described below with reference to FIG. 18.

In FIG. 18, the control unit 21 refers to the operation data Dp, and determines whether the operation of tilting the analog stick 91 has been performed (step S111).

In step S112, the control unit 21 changes the direction of the third object OBJ3 based on the tilt direction and tilt amount of the analog stick 91, and proceeds to step S113. For example, the control unit 21 obtains the tilt direction and tilt amount of the analog stick 91 indicated by the operation data Dp, changes the orientation of the third object OBJ3 in the virtual space to the direction in the virtual space corresponding to the tilt direction, and moves the third object OBJ3 in the direction corresponding to the orientation at a speed corresponding to the tilt amount, and updates the object data Dq.

In step S113, the control unit 21 determines whether the mouse sensor 96 has detected an object.

In step S114, the control unit 21 calculates a spray position and a spray direction based on the position and direction of the third object OBJ3 in the virtual space, updates the object data Dq, and proceeds to the next step.

Next, the control unit 21 sprays the fourth object OBJ4 based on the spray position and spray direction calculated in step S114 and updates the object data Dq (step S115), and ends the subroutine.

Referring back to FIG. 17, if in step S103, the control unit 21 determines that the landscape holding operation is not being performed, the control unit 21 executes other processes (step S105), and proceeds to step S106. As an example, the control unit 21 executes a process related to data that is output from the input apparatus 9 by the normal orientation operation.

Thus, in the information processing system 1b of the second embodiment, it is determined whether the input apparatus 9, which has the mouse function, is in an orientation in which the landscape holding operation is being performed, and if the input apparatus 9 is in such an orientation, then when an object to be detected is positioned close to the aperture forming the light guide path of the mouse sensor, the motion of an object is controlled. Therefore, novel operation experience and amusingness can be provided in terms of the operation of the input apparatus. In addition, in the example game process of the second embodiment, when the result of detection indicating that the state in which an object to be detected has not been detected is changed to the state in which an object to be detected has been detected is obtained from the mouse sensor, a predetermined action of an object is performed. Thus, an operation similar to that which is performed using an operation button can be performed using the aperture for a mouse sensor, so that a novel operation feeling can be provided using a mouse sensor.

It should be noted that it may be determined or estimated whether an input apparatus is in an orientation in which the upside-down orientation operation or landscape holding operation is being performed, in other embodiments. For example, in the information processing system 1, by executing a prompt process of outputting an image, sound (voice or speech), or the like for prompting the user to operate an input apparatus in an orientation in which the upside-down orientation operation is performed or an orientation in which the landscape holding operation is performed, it may be estimated that the input apparatus is operated by the prompted user in an orientation in which the upside-down orientation operation is performed or an orientation in which the landscape holding operation is performed. This estimation may be performed based on the operation of a specific operation button performed by the user or the blocking of the aperture for the mouse sensor performed by the user in response to the prompt process.

The objects described in the first and second embodiments are merely illustrative, and are not particularly limited. In addition, the motion of each object according to an operation performed on an input apparatus is merely illustrative and is not particularly limited. As an example, in the second embodiment, the third object OBJ3 may be a hand, and by performing an operation of blocking the aperture, an action of touching the position with the hand may be performed. At that time, based on the presence of another object at the position, or the position with respect to another object, a reaction of the other object may be performed. In addition, in the first embodiment, a game process may include only one of the first object OBJ1 and the second object OBJ2, and may include another object operated using an input apparatus.

In addition, in the first and second embodiments, the input apparatus may not include an inertial sensor (e.g., an angular velocity sensor and/or an acceleration sensor), and the output of an inertial sensor may not be used in a game process. It should be noted that even in the case in which the input apparatus includes an inertial sensor, the output of the inertial sensor may not be used in a game process.

In addition, although an example in which an information process is executed in the information processing apparatus 2 has been used in the foregoing description, at least a portion of the steps in the process may be executed in another apparatus. In addition, the process may be executed by a plurality of processors included in an information processing system including at least one information processing apparatus cooperating with each other.

While several non-limiting example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present non-limiting example and common technical knowledge. It should be understood throughout the present specification that expression of a singular form includes the concept of its plurality unless otherwise mentioned. Specifically, articles or adjectives for a singular form (e.g., “a,” “an,” “the,” etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present non-limiting example pertain. If there is any inconsistency or conflict, the present specification (including the definitions) shall prevail.

As described above, the present example is useful as, for example, a computer-implemented method, storage medium, game program, game system, and the like for the purpose of providing novel operation experience and amusingness.

What is claimed is:

1. A computer-implemented method comprising:
determining whether a mouse is in a first orientation in which a bottom surface of the mouse is exposed, based on inertial sensor data output from an inertial sensor included in the mouse; and
in response to a determination that the mouse is in the first orientation, executing a first game process based on the inertial sensor data, and mouse sensor data output from a mouse sensor included in the mouse, wherein the mouse sensor is configured to detect light entering through an aperture in the bottom surface.

2. The computer-implemented method according to claim 1, wherein
the first game process includes a process of controlling a first object based on the inertial sensor data and the mouse sensor data.

3. The computer-implemented method according to claim 2, wherein
the first game process includes
a process of determining a first parameter of the first object based on the inertial sensor data, and
a process of determining a second parameter of the first object based on the mouse sensor data.

4. The computer-implemented method according to claim 3, wherein
the first game process includes
a process of controlling an orientation in a first direction of the first object based on the inertial sensor data, and
a process of controlling an orientation in a second direction of the first object based on the mouse sensor data.

5. The computer-implemented method according to claim 2, wherein
the first game process includes
a process of controlling a position of the first object based on the inertial sensor data, and
a first process related to the position of the first object and based on the mouse sensor data.

6. The computer-implemented method according to claim 5, wherein the first process is a process of launching a second object from the first object.

7. The computer-implemented method according to claim 6, wherein
the second object is launched in response to the mouse sensor data indicating that a previously detected object is no longer detected.

8. The computer-implemented method according to claim 2, wherein
the first game process includes
a process of controlling an orientation of the first object based on the inertial sensor data, and
a first process related to the orientation of the first object and based on the mouse sensor data.

9. The computer-implemented method according to claim 8, wherein the first process is a process of launching a second object from the first object.

10. The computer-implemented method according to claim 1, further comprising:
determining whether the mouse is in a second orientation in which the bottom surface is exposed and that is different from the first orientation, based on the inertial sensor data; and
in response to a determination that the mouse is in the second orientation, executing a second game process,
wherein
the first game process includes a process of controlling a first object based on the mouse sensor data, and
the second game process includes a process of controlling the first object based on the mouse sensor data in a manner different from that of the first game process.

11. One or more non-transitory computer-readable storage media having stored therein instructions that, when executed, cause one or more processors to perform operations comprising:
determining whether a mouse is in a first orientation in which a bottom surface of the mouse is exposed, based on inertial sensor data output from an inertial sensor included in the mouse; and
in response to a determination that the mouse is in the first orientation, executing a first game process based on the inertial sensor data, and mouse sensor data output from a mouse sensor included in the mouse, wherein the mouse sensor is configured to detect light entering through an aperture in the bottom surface.

12. The one or more non-transitory computer-readable storage media according to claim 11, wherein
the first game process includes a process of controlling a first object based on the inertial sensor data and the mouse sensor data.

13. The one or more non-transitory computer-readable storage media according to claim 12, wherein
the first game process includes
a process of determining a first parameter of the first object based on the inertial sensor data, and
a process of determining a second parameter of the first object based on the mouse sensor data.

14. The one or more non-transitory computer-readable storage media according to claim 13, wherein
the first game process includes
a process of controlling an orientation in a first direction of the first object based on the inertial sensor data, and
a process of controlling an orientation in a second direction of the first object based on the mouse sensor data.

15. The one or more non-transitory computer-readable storage media according to claim 12, wherein
the first game process includes
a process of controlling a position of the first object based on the inertial sensor data, and
a first process related to the position of the first object and based on the mouse sensor data.

16. The one or more non-transitory computer-readable storage media according to claim 12, wherein
the first game process includes
a process of controlling an orientation of the first object based on the inertial sensor data, and
a first process related to the orientation of the first object and based on the mouse sensor data.

17. The one or more non-transitory computer-readable storage media according to claim 15, wherein
the first process is a process of launching a second object from the first object.

18. The one or more non-transitory computer-readable storage media according to claim 17, wherein
the second object is launched in response to the mouse sensor data indicating that a previously detected object is no longer detected.

19. The one or more non-transitory computer-readable storage media according to claim 11, further comprising:
determining whether the mouse is in a second orientation in which the bottom surface is exposed and that is different from the first orientation, based on the inertial sensor data; and
in response to a determination that the mouse is in the second orientation, executing a second game process,
wherein
the first game process includes a process of controlling a first object based on the mouse sensor data, and
the second game process includes a process of controlling the first object based on the mouse sensor data in a manner different from that of the first game process.

20. A game system comprising:
one or more processors;
a mouse; and
one or more memories storing instructions to perform operations comprising:
determining whether the mouse is in a first orientation in which a bottom surface of the mouse is exposed, based on inertial sensor data output from an inertial sensor included in the mouse; and
in response to a determination that the mouse is in the first orientation, executing a first game process based on the inertial sensor data, and mouse sensor data output from a mouse sensor included in the mouse, wherein the mouse sensor is configured to detect light entering through an aperture in the bottom surface.
